(19) United States
(12) Patent Application Publication
(10) Pub. No.: US 2026/0255083 A1
(43) Pub. Date: Aug. 27, 2026

(54) IMAGE SENSOR WITH SHARED COMPARATOR ARCHITECTURE

(71) Applicant: Meta Platforms Technologies, LLC, Menlo Park, CA (US)

(72) Inventors: Raffaele Capoccia, Zürich (CH); Ankita Pujar, Milpitas, CA (US); Jiajia Wu, Redmond, WA (US); Wenjuan Guo, Austin, TX (US); Sri Harsha Manjunath, Folsom, CA (US); Chunyang Zhai, Sunnyvale, CA (US); Robert Wiser, Palo Alto, CA (US); Xinqiao Liu, MEDINA, WA (US); Ramakrishna Chilukuri, San Jose, CA (US); Song Chen, Redmond, WA (US)

(21) Appl. No.: 19/549,555

(22) Filed: Feb. 25, 2026

Related U.S. Application Data
(60) Provisional application No. 63/764,485, filed on Feb. 27, 2025.

(51) Int. Cl. H04N 25/771; H04N 25/772; H04N 25/78; H04N 25/79

(52) U.S. Cl. CPC H04N 25/771; H04N 25/772; H04N 25/78; H04N 25/79

(57) ABSTRACT

An imaging device includes a plurality of image pixels, an analog layer, and a memory layer. The plurality of image pixels is disposed on an imaging layer. The analog layer includes a shared comparator configured to receive image charges from the plurality of image pixels. The memory layer includes reset memory banks and signal memory banks. The analog layer is disposed between the imaging layer and the memory layer. The comparator output of the shared comparator controls a memory control line for both the reset memory banks and the signal memory banks.

### CROSS-REFERENCE TO RELATED APPLICATIONS

This application claims priority to U.S. provisional Application No. 63/764,485 filed February 27, 2025, which is hereby incorporated by reference.

### TECHNICAL FIELD

This disclosure relates generally to optics, and in particular to image sensor technology.

### BACKGROUND INFORMATION

Image sensors typically include a two-dimensional array of image pixels. The image sensor may include processing logic and readout logic that converts analog signals to digital signals to generate a digital image. In general, image sensors are trending toward smaller physical sizes, although the shrinking footprint brings tradeoffs between the size of the image pixel and the footprint available for readout circuitry and local memory, which can impact image quality and sensor functionality.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates an example three-layer imaging device, in accordance with aspects of the disclosure.

FIGS. 2A and 2B illustrate an example shared pixel structure that may be utilized in an image pixel array on the imaging layer of FIG. 1, in accordance with aspects of the disclosure.

FIG. 3 illustrates an example of an analog layer that includes a ramp circuit and a shared comparator, in accordance with aspects of the disclosure.

FIG. 4 illustrates an example memory layer of an imaging device that includes memory logic, a digital counter, reset memory banks, and signal memory banks, in accordance with aspects of the disclosure.

FIG. 5 illustrates an example imaging device that includes three layers, in accordance with aspects of the disclosure.

FIG. 6 illustrates a timing diagram for operation of imaging devices, in accordance with aspects of the disclosure.

FIGS. 7 and 8 illustrate example timing diagrams for operating an imaging device that includes a shared comparator, in accordance with aspects of the disclosure.

FIG. 9 illustrates a flow chart illustrating an example process of capturing images with a shared comparator, in accordance with aspects of the disclosure.

FIG. 10 illustrates a head-mounted device that includes one or more cameras that may incorporate a shared comparator, in accordance with aspects of the disclosure.

### DETAILED DESCRIPTION

Embodiments of imaging devices with shared-comparator sampling are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm – 700 nm. Non-visible light may be defined as light having wavelengths that are outside the visible light range, such as ultraviolet light and infrared light. Infrared light having a wavelength range of approximately 700 nm – 1 mm includes near-infrared light. In aspects of this disclosure, near-infrared light may be defined as having a wavelength range of approximately 700 nm - 1.6 µm.

In aspects of this disclosure, the term “transparent” may be defined as having greater than 90% transmission of light. In some aspects, the term “transparent” may be defined as a material having greater than 90% transmission of visible light.

A digital pixel sensor (DPS) incorporates an analog-to-digital converter (ADC) and a digital memory within each pixel. In a DPS implemented with two layers of silicon, the first layer is typically responsible for converting incoming light into an electrical signal, while the second layer handles converting this signal from the analog to the digital domain and stores the final values into a digital memory. In a DPS, the size and amount of digital memory integrated into each pixel often act as the limiting factors when reducing the pixel size. Current DPS pixels are larger compared to other global shutter image sensor architectures due to the constraints of integrating both ADC and memory within the same layer. As a result, DPS sensors are often limited to low-resolution arrays, as reducing pixel size becomes challenging. At the same time, it is common for state-of-the-art DPS designs to have limited memory for signal storage, preventing the ability to increase available memory to enhance image quality or add additional sensor functionalities.

In implementations of the disclosure, three layers are used to fabricate an imaging device. In some examples, three layers of silicon are used to implement a DPS pixel and memory can be moved to a dedicated layer and implemented in an advanced technology node, allowing for a more aggressive size reduction of the overall imaging device. In this configuration, further pixel size reduction can be achieved by sharing the main analog components required for the ADC.

This disclosure includes an imaging device architecture that leverages a shared comparator across multiple pixels to achieve a significant reduction in the overall physical size of the imaging device. By decoupling the comparator design from the individual pixel constraints, the shared ADC architecture can better take advantage of stacking multiple layers of silicon, enabling reduced pixel size while maintaining proper circuit performance and integrating additional resources.

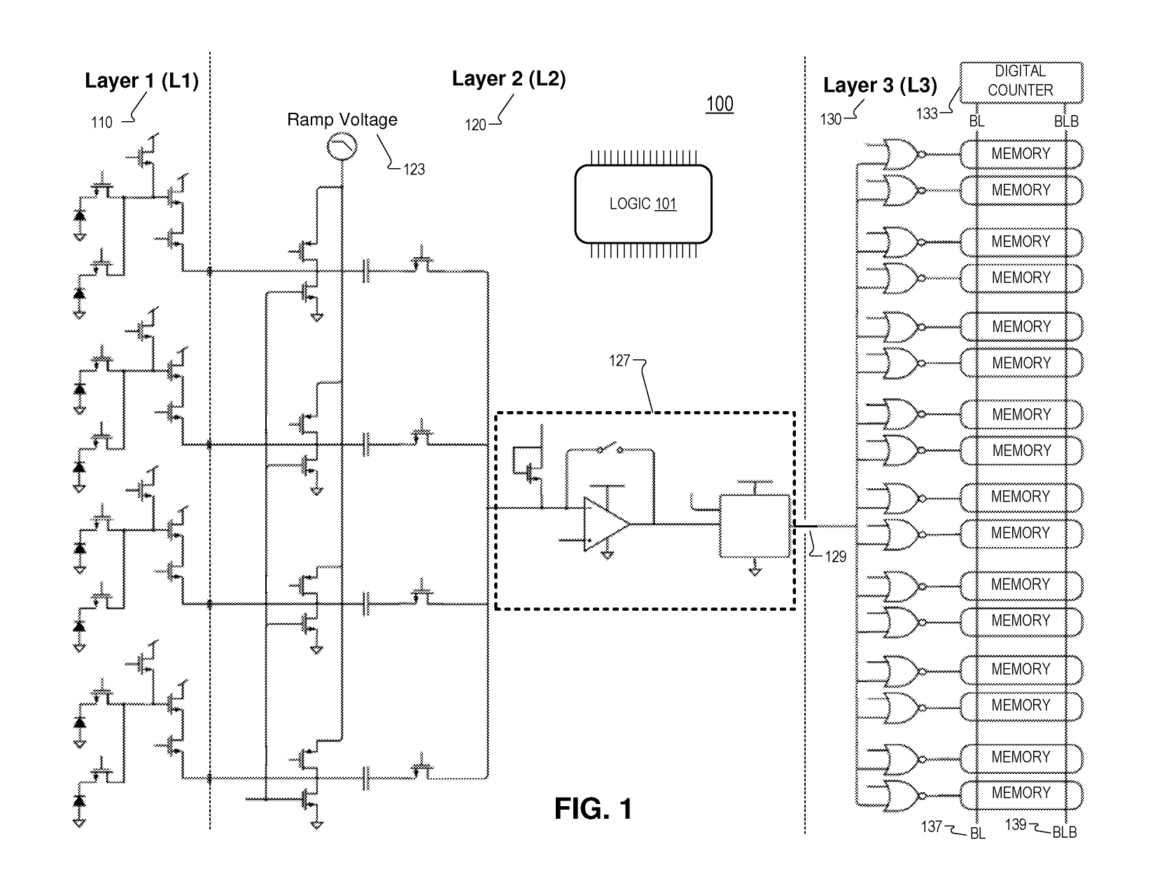

The approach adopted in this disclosure is not limited to a specific stacking configuration and can be applied to various designs. In one embodiment, a three-layer stacking configuration is shown in FIG. 1, where increased memory resources implemented in the third layer support additional features such as digital correlated double sampling (CDS) within the imaging device. This example demonstrates how stacking multiple semiconductor layers (e.g. silicon layers) can enable not only size reductions but also the integration of additional capabilities to improve overall system performance. However, the aspects of this disclosure remain applicable to other stacking configurations that benefit from efficient resource sharing and additional available memory.

Among the challenges improved or solved by the disclosure include: (1) Pixel Size Limitation: traditional DPS designs require each pixel to have a dedicated ADC comparator, making it difficult to shrink pixel size efficiently; (2) Limited Memory Scaling in Two-Layer DPS: in conventional two-layer designs, pixel size is restricted by the amount of digital memory that can fit within the pixel; and (3) Increased Functionality with Memory Expansion.

By way of summary, this disclosure addresses the limitations of existing DPS technology by introducing a shared ADC comparator among multiple pixels and by leveraging multi-layer stacking for more advanced capabilities. Implementations of the disclosure address the problems described above by re-thinking the DPS architecture to take full advantage of multi-layer silicon stacking in image sensors. It redesigns circuits to efficiently share resources between multiple pixels, reducing pixel size while improving performance and functionality. Implementations of the disclosure reduce DPS size by sharing the ADC comparator across multiple pixels and thereby reducing circuit area. Features of the disclosure enhance sensor capabilities by using a multiple layer stacking approach and separating memory from analog components for better efficiency. The additional memory enables features like digital correlated double sampling (DCDS) for noise reduction. These concepts may be implemented as a three-layer stacking sensor, where the second layer is dedicated to analog components of the ADC. The third layer, fabricated in a more advanced technology node, may be used to take advantage of conventional integrated SRAM with increased memory density. Since implementations of the disclosure are not limited to a three-layer stacking configuration, other embodiments with different stacking layer technologies can also be implemented. Likewise, since this disclosure is not restricted to SRAM memory technology, other embodiments can utilize different high-density integrated memory technologies. Even though DPS has traditionally been used for low-power, low-resolution global shutter image sensors in computer vision, features of the disclosure may extend to high-resolution image sensors. This enables DPS to be used in photographic and advanced computer vision applications where high-resolution images are preferred or required. These and other features are described in more detail with respect to FIGS. 1-10.

FIG. 1 illustrates an example three-layer imaging device 100, in accordance with aspects of the disclosure. Imaging device 100 include a first layer (L1) 110, a second layer (L2) 120, and a third layer (L3) 130. Layer 110 is an imaging layer, layer 120 may be referred to as an “analog layer” and layer 130 may be referred to as a “memory layer.” Analog layer 120 is disposed between imaging layer 110 and memory layer 130. The memories illustrated in memory layer 130 may be implemented as Static Random Access Memory (SRAM) or other suitable memory technology.

Imaging layer 110 includes a plurality of image pixels configured to capture image light. The plurality of image pixels may be arranged in rows and columns to form a two-dimensional image pixel array, for example. The image pixels in the array may be CMOS image pixels. Image charges measured by imaging layer 110 are provided to analog layer 120 to convert the analog image charges to digital representations for storage in the digital memory included in memory layer 130. Analog layer 120 includes a shared comparator 127 configured to receive image charges from the plurality of image pixels. Analog layer 120 also include a ramp circuit to apply a ramp voltage 123. Memory layer 130 includes reset memory banks and signal memory banks. A comparator output 129 of the shared comparator 127 may control a memory control line (e.g. a word line (WL)) for both the reset memory banks and the signal memory banks in the memories. A digital counter 133 is synchronized with the ramp voltage 123. A memory bit line (BL) 137 and a memory bit line bar (BLB) 139 are connected to digital counter 133 and are also interconnected with the memory banks. BLB 139 may carry the complementary (inverted) signal as BL 137.

Imaging device 100 may include processing logic 101 that is included in one or more layer 110, 120, or 130. Processing logic 101 may drive the signals to readout the image pixels in layer 110. Processing logic 101 may drive various switches in layer 120 to coordinate providing the ramp voltage 123 and image signals to shared comparator 127 at the appropriate times. Processing logic 101 may drive various enable signals in layer 130 so that the digital representations of the image charges are stored in the appropriate reset memory bank or signal memory bank, for example.

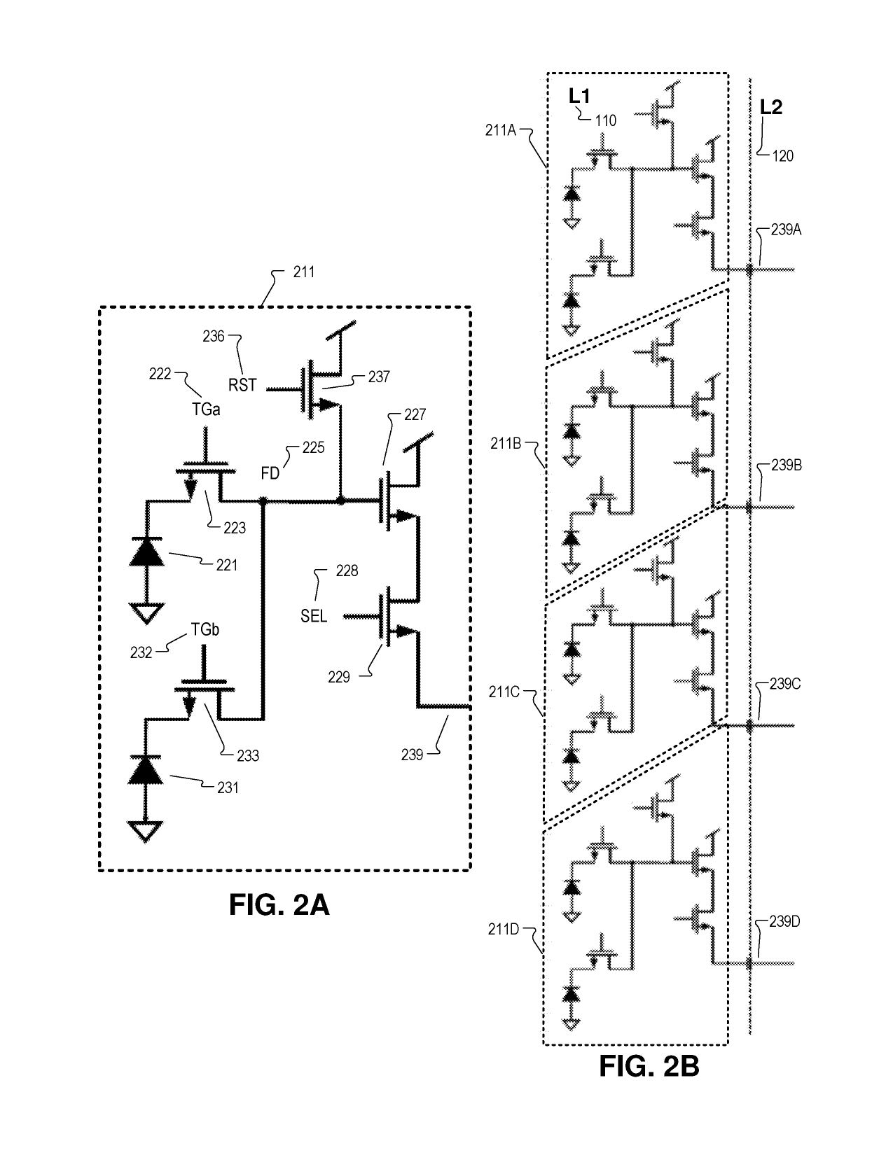

FIGS. 2A and 2B illustrate an example shared pixel structure 211 that may be utilized in an image pixel array on imaging layer 110 of FIG. 1, in accordance with aspects of the disclosure. FIG. 1 includes four of shared pixel structure 211 in imaging layer 110 as an example of a pixel architecture that may be utilized in the disclosure. Other pixel structures may also be used in accordance with aspects of the disclosure. Thousands or millions of pixel structure 211 may be included in an image pixel array included in imaging devices of the disclosure.

Shared pixel structure 211 includes a first photodiode 221 that shares a floating diffusion (FD) 225 with a second photodiode 231. First photodiode 221 and second photodiode 231 also share a reset (RST) transistor 237, a source follower (SF) transistor 227, and a select (SLT) transistor 229 to readout image charge accumulated in the photodiodes during an accumulation period.

In operation, incoming image light is incident on photodiode 221. During an exposure period, image charge accumulates within photodiode 221. After the exposure period, a transfer signal TGa 222 drives transfer gate 223 closed to move the accumulated image charge to floating diffusion (FD) 225. FD 225 functions as a photo-generated charge accumulator. The transfer signal TGa 222 may be a pulse. The image charge transferred to floating diffusion 225 is amplified by source follower transistor 227 and a select signal (SEL) 228 drives select transistor 229 to provide the amplified image charge signal as image charge 239 (onto the column line) to be converted from an analog signal to a digital signal in analog layer 120. After image charge 239 has been provided for conversion, a reset signal (RST) 236 may be driven onto a gate of reset transistor 237 to reset FD 225 to a reset voltage (also known as a “reference voltage”).

Image charge accumulated in second photodiode (e.g. photodiode 231) during a second exposure period may be transferred to FD 225 when a transfer signal TGb 232 drives transfer gate 233 closed to move the accumulated image charge from second photodiode 231 to floating diffusion 225. In some implementations, the second exposure period for the second photodiode 231 overlaps with the first exposure period of the first photodiode 221. In some implementations, the second exposure period for the second photodiode 231 does not overlap in time with the first exposure period of the first photodiode 221.

Shared pixel structure 211 may be operated in a manner to facilitate an imaging technique known as correlated double sampling (CDS). For example, a reset value may be readout of shared pixel structure 211 for each photodiode in pixel structure 211 and the reset value may be stored in a reset memory bank associated with the photodiode or pixel. The reset value may be subtracted from a signal value generated during an exposure period for the photodiode/pixel in order to generate a more accurate representation of the image light incident on the photodiode or pixel during the exposure period.

FIG. 2B illustrates four shared pixel structures 211A, 211B, 211C, and 211D that generate image charges 239A, 239B, 239C, and 239D, respectively. The image charges 239A, 239B, 239C, and 239D are provided from the image pixels in imaging layer (L1) 110 to the analog layer (L2) 120, in FIG. 2B.

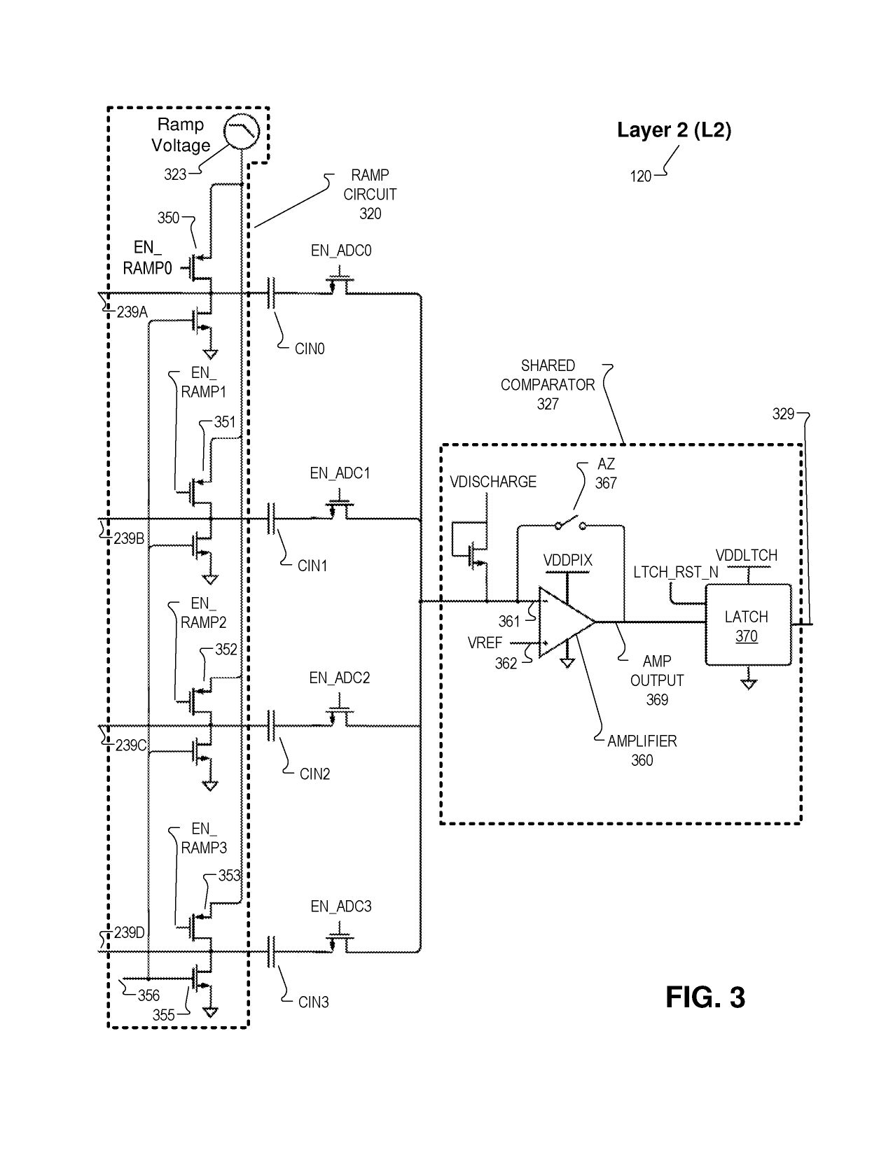

FIG. 3 illustrates an example of an analog layer 120 that includes a ramp circuit 320 and a shared comparator 327, in accordance with aspects of the disclosure. Analog layer 120 further includes input capacitors CIN0, CIN1, CIN2, and CIN3 coupled between the image pixels of layer 110 and shared comparator 327. Input capacitor CIN0 may receive image charge 239A, input capacitor CIN1 may receive image charge 239B, input capacitor CIN2 may receive image charge 239C, and input capacitor CIN3 may receive image charge 239D. Input capacitors CIN0, CIN1, CIN2, and CIN3 may function to bypass the DC voltage from the image pixels while lowering the voltage level for the input on first terminal 361 of amplifier 360. Input capacitors CIN0, CIN1, CIN2, and CIN3 may also function to sample the output level of the corresponding image pixel.

In FIG. 3, example ramp circuit 320 includes ramp-enabled switches 350, 351, 352, and 353 configured to sequentially apply ramp voltage 323 to the input capacitors CIN0, CIN1, CIN2, and CIN3. Ramp-enabled switches 350, 351, 352, and 353 may be driven by signals EN_RAMP0, EN_RAMP1, EN_RAMP2, and EN_RAMP3, respectively. Enable signals EN_RAMP0, EN_RAMP1, EN_RAMP2, and EN_RAMP3 may be driven onto transistor gates of ramp enabled switches 350, 351, 352, and 353, as shown in FIG. 3.

Shared comparator 327 includes a differential input amplifier 360 that includes a first terminal 361 coupled to input capacitors CIN0, CIN1, CIN2, and CIN3 through enable switches EN_ADC0, EN_ADC1, EN_ADC2, and EN_ADC3, respectively. The differential input amplifier 360 also includes a second terminal 362 that receives a reference voltage VREF, in the illustrated example of FIG. 3. Enable switches EN_ADC0, EN_ADC1, EN_ADC2, and EN_ADC3 may be configured to be sequentially opened during a reset phase that measures reset values for the plurality of image pixels. Enable switches EN_ADC0, EN_ADC1, EN_ADC2, and EN_ADC3 may be configured to be sequentially opened during a signal phase that measures signal values for the plurality of image pixels where the signal values are accumulated on photodiodes 221 and/or 231 during one or more exposure periods.

Shared comparator 327 is configured to convert analog image charge signals to digital representations of the image charge signals. Example shared comparator 327 includes a differential input amplifier 360 configured to receive the image charges from the plurality of image pixels via input capacitors CIN0, CIN1, CIN2, and CIN3 and the coordinated switching of enable switches EN_ADC0, EN_ADC1, EN_ADC2, and EN_ADC3. Example shared comparator 327 also includes a latch 370 configured to flip a latch output 329 in response to receiving an amplifier output 369 from differential input amplifier 360. Latch output 329 may be provided to memory layer 130 as the comparator output of shared comparator 327. In an implementation, comparator output 329 generates pulses on a memory control line (e.g. WL) to write to the reset memory banks and/or the signal memory banks.

In FIG. 3, shared comparator 327 includes an autozero switch 367 coupled between the first terminal 361 of the differential input amplifier 360 and a latch 370. Latch 370 is configured to flip a latch output (329) in response to receiving an amplifier output 369 from differential input amplifier 360.

In FIG. 3, example shared comparator 327 also includes a discharge circuit coupled to the first terminal 361of the differential input amplifier 360. The discharge circuit is tied to a discharge voltage VDISCHARGE and provides a discharge path for charge stored in the input capacitors CIN0, CINb, CIN2, and CIN3. This discharge circuit may prevent the input of amplifier 360 from being driven to negative voltages. In the illustration of FIG. 3, the discharge circuit includes a diode-connected transistor tied to the discharge voltage VDISCHARGE to clamp the input of amplifier 360.

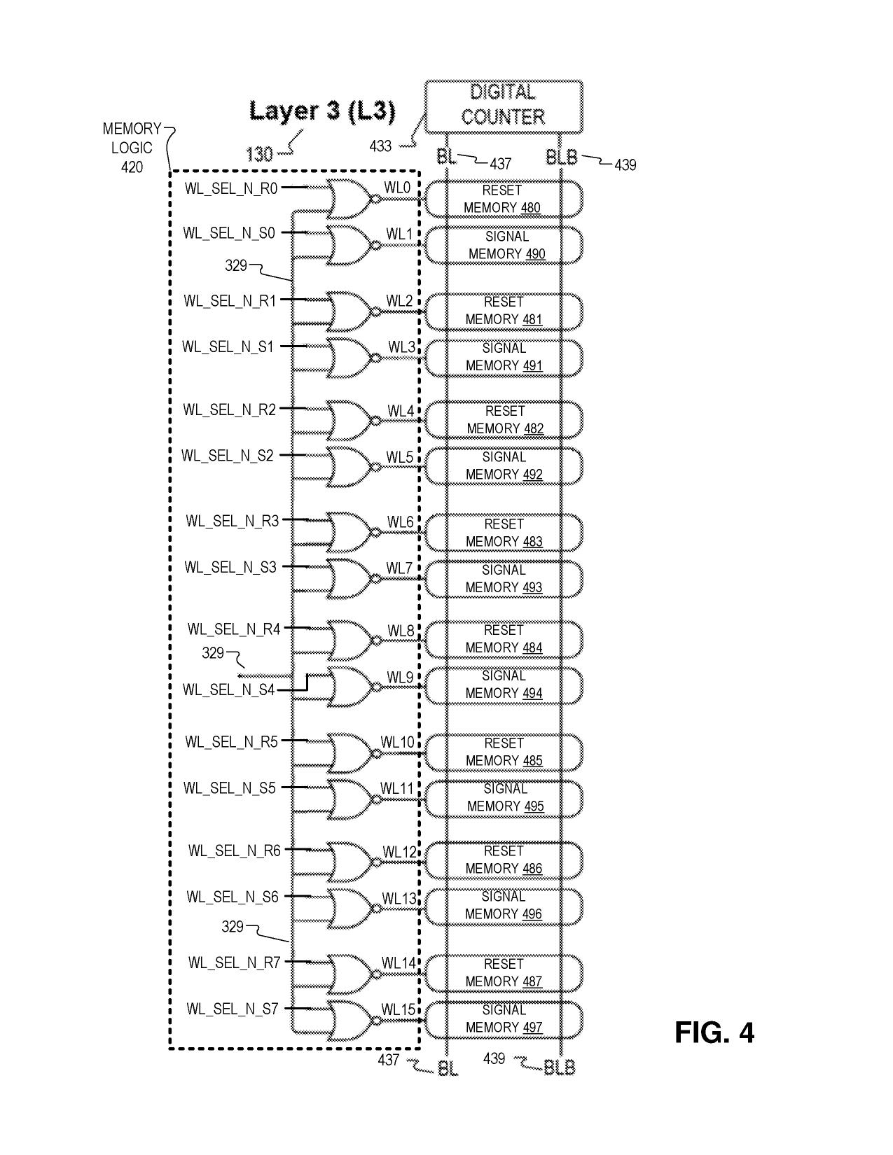

FIG. 4 illustrates an example memory layer 130 of an imaging device that includes memory logic 420, a digital counter 433, reset memory banks, and signal memory banks, in accordance with aspects of the disclosure. FIG. 4 shows comparator output 329 of shared comparator 327 is provided to memory logic 420. Comparator output 329 of the shared comparator 327 controls a memory control line for both the reset memory banks and the signal memory banks in FIG. 4. In the specific illustration, comparator output 329 controls the word line (WL) for the reset memory banks and the signal memory banks in memory layer 130. Memory logic 420 is electrically coupled between the latch 370 and the signal memory banks 490, 491, 492, 493, 494, 495, 496, and 497. In implementations, memory logic 420 is also electrically coupled between the latch 370 and the reset memory banks 480, 481, 482, 483, 484, 485, 486, and 487. Memory logic 420 is configured to output the word line (WL) for the reset memory banks and the signal memory banks in response the comparator output 329 received from latch 370. When comparator output 329 flips, the WL is disabled and the digital value of digital counter 433 (that corresponds to the image charge that flipped the comparator output 329) is stored in the memory bank that was being written.

The example memory logic 420 includes a plurality of NOR gates having individual selection inputs to individually select which of the reset memory banks or signal memory banks will be written to. The remaining inputs of the NOR gates are coupled to receive the comparator output 329. In other words, one input of each NOR gates is coupled to receive comparator output 329 while the other input of the NOR gate is configured to receive the individual selection signal such as WL_SEL_N_R0 or WL_SEL_N_S0.

Word lines WL0-WL15 control access to memories. Hence, these word lines control when data can be written to the memories. In the example of FIG. 4, WL0 controls write- access to reset memory bank 480 and WL1 controls write-access to signal memory bank 490. Reset memory 480 and signal memory 490 may correspond to the first photodiode (e.g. photodiode 221) in shared pixel structure 211A. Similarly, WL2 controls write-access to reset memory bank 481 and WL3 controls write-access to signal memory bank 491. Reset memory 481 and signal memory 491 may correspond to the first photodiode (e.g. photodiode 221) in shared pixel structure 211B. WL4 controls write-access to reset memory bank 482 and WL5 controls write-access to signal memory bank 492. Reset memory 482 and signal memory 492 may correspond to the first photodiode (e.g. photodiode 221) in shared pixel structure 211C. WL6 controls write-access to reset memory bank 483 and WL7 controls write-access to signal memory bank 493. Reset memory 483 and signal memory 493 may correspond to the first photodiode (e.g. photodiode 221) in shared pixel structure 211D.

WL8 controls write- access to reset memory bank 484 and WL9 controls write-access to signal memory bank 494. Reset memory 484 and signal memory 494 may correspond to the second photodiode (e.g. photodiode 231) in shared pixel structure 211A. Similarly, WL10 controls write-access to reset memory bank 485 and WL11 controls write-access to signal memory bank 495. Reset memory 485 and signal memory 495 may correspond to the second photodiode (e.g. photodiode 231) in shared pixel structure 211B. WL12 controls write-access to reset memory bank 486 and WL13 controls write-access to signal memory bank 496. Reset memory 486 and signal memory 496 may correspond to the second photodiode (e.g. photodiode 231) in shared pixel structure 211C. WL14 controls write-access to reset memory bank 487 and WL15 controls write-access to signal memory bank 497. Reset memory 487 and signal memory 497 may correspond to the second photodiode (e.g. photodiode 231) in shared pixel structure 211D. Each image pixel in the plurality of image pixels may have a corresponding reset memory bank to store reset values and a corresponding signal memory bank to store signal values. And, the reset value stored in the reset memory bank may be subtracted from the signal value in the signal memory to calculate a corrected digital signal value for a given image pixel.

Digital counter 433 is configured to count up or down in synchronization with the ramp voltage 323 of the ramp circuit 320 of FIG. 3. Memory bit line (BL) 437 is connected to digital counter 433 and interconnected with the reset memory banks 480-487 and the signal memory banks 490-497. In FIG. 4, memory bit line bar (BLB) 439 is connected to digital counter 433 and are also interconnected with reset memory banks 480-487 and the signal memory banks 490-497. BLB 439 may carry the complementary (inverted) signal as BL 437. BL 437 may only be enabled to write to a given memory when the word line (e.g. WL0-WL15) is activated for a specific memory to be written to with the comparator output 329.

FIG. 4 includes word line selection signals WL_SEL_N_R0, WL_SEL_N_R1, WL_SEL_N_R2, WL_SEL_N_R3, WL_SEL_N_R4, WL_SEL_N_R5, WL_SEL_N_R6, and WL_SEL_N_R7. In order for reset memory banks 480-487 to be written, the corresponding word line selection signals on the XOR gate coupled to a given reset memory bank must be enabled to allow the reset memory bank to be written to. Similarly, FIG. 4 includes word line selection signals WL_SEL_N_S0, WL_SEL_N_S1, WL_SEL_N_S2, WL_SEL_N_S3, WL_SEL_N_S4, WL_SEL_N_S5, WL_SEL_N_S6, and WL_SEL_N_S7. In order for signal memory banks 490-497 to be written, the corresponding word line selection signals on the XOR gate coupled to a given signal memory bank must be enabled to allow the signal memory bank to be written to.

During single-slope ADC operation, ramp voltage 323 is applied to one side of an input capacitor (e.g. CIN0, CIN1, CIN2, or CIN3) through the EN_RAMP switches 350-353. This ramp voltage 323 changes the voltage at the input on first terminal 361 of amplifier 360, causing amplifier output 369 to flip when the input matches the reference voltage VREF on second terminal 362.

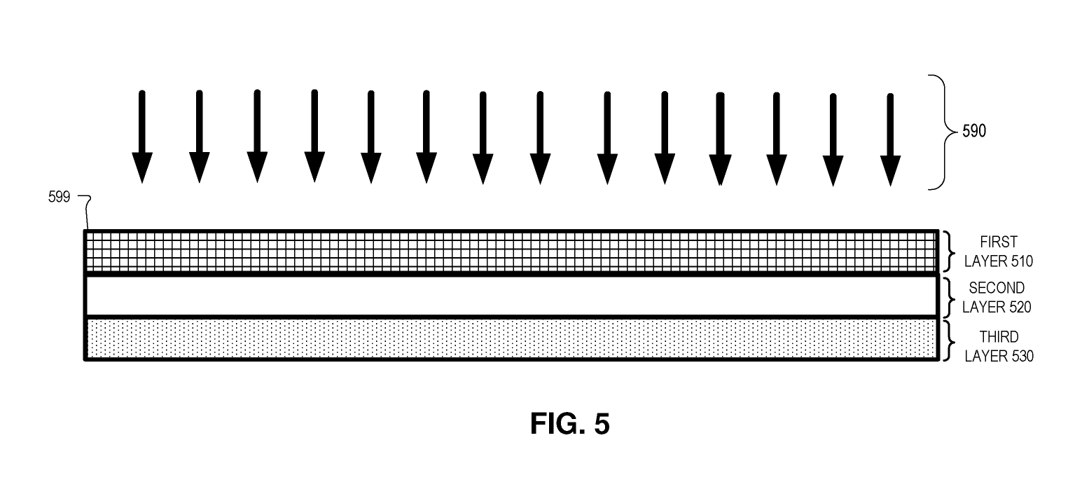

FIG. 5 illustrates an example imaging device 599 that includes three layers 510, 520, and 530, in accordance with aspects of the disclosure. First layer 510 is configured to receive incident imaging light 590. Image pixels in first layer 510 may sense imaging light 590. First layer 510 may be an example of imaging layer 110. Second layer 520 is disposed between first layer 510 and third layer 530. Analog layer 120 may be included in second layer 520, for example. Memory layer 130 may be included in third layer 530. By placing the analog readout circuitry (e.g. ADC functionality of shared comparator 327) and the memory onto second layer 520 and third layer 530, first layer 510 may be configured with image pixels with larger surfaces areas for fixed dimensions (e.g. width and depth) of imaging device 599.

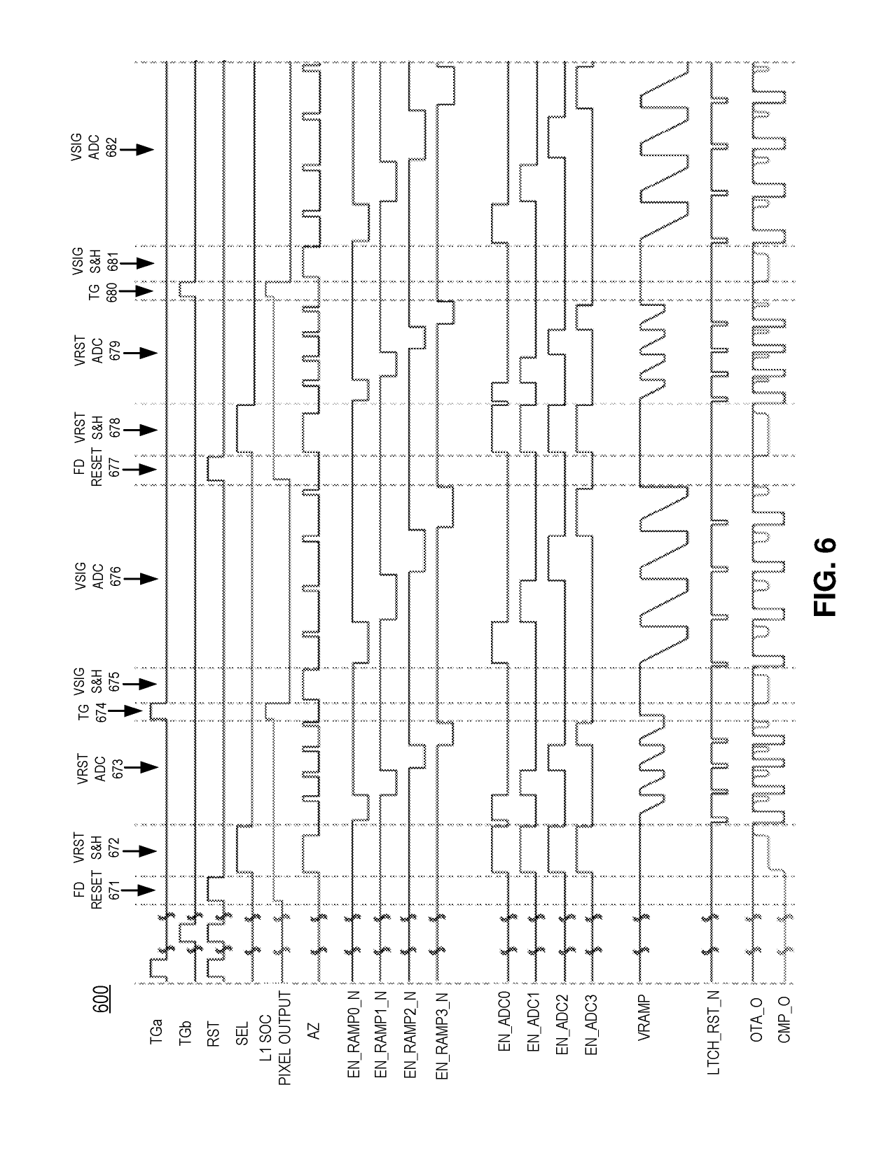

FIG. 6 illustrates a timing diagram 600 for ADC operation of imaging devices, in accordance with aspects of the disclosure. Timing diagram 600 highlights the driving signals and the voltage waveforms up to the comparator output (e.g. comparator output 329) and illustrates how the shared comparator operates in this disclosure.

FIG. 6 illustrates signals TGa, TGb, RST, SEL, L1 SOC Pixel Output, AZ, EN_RAMP0_N, EN_RAMP1_N, EN_RAMP2_N, EN_RAMP3_N, EN_ADC0, EN_ADC1, EN_ADC2, EN_ADC3, VRAMP, LTCH_RST_N, OTA_O, and CMP_O during various time periods. The time periods include Floating Diffusion reset 671, Reset Voltage Sample and Hold 672, VRST ADC 673, Transfer Gate 674, Signal Voltage Sample and Hold 675, Signal Voltage ADC 676, Floating Diffusion Reset 677, Reset Voltage Sample and Hold 678, Voltage Reset ADC 679, Transfer Gate 680, Signal Voltage Sample and Hold 681, and Signal Voltage ADC 682.

When the imaging device starts ADC operation after the exposure is almost complete, the FD node (e.g. FD 225) on the L1 pixel is first reset. Then this reset level is buffered by the SF (e.g. SF transistor 227) and applied to one end of each input capacitor as a result of the pixel select transistor (e.g. select transistor 229) being enabled. During the reset sample-and-hold operation of time period 672, the amplifier 360 is active and it is set in an autozero (AZ) state (AZ switch 367 is closed). In this state, the AZ voltage of amplifier 360 is applied to the other end of all input capacitors with EN_ADC switches that are enabled.

The sampling operation is performed by opening the AZ switch 367. After the reset sampling operation, the SF output reset level minus the AZ voltage is stored on the input capacitors (e.g. CIN0-CIN3). During the next phase (reset ADC), the ramp voltage (from the ramp generator) is sequentially connected to each input capacitor via the EN_RAMP switches 350-353. The other end of the input capacitor is connected to the amplifier 360 through its EN_ADC switch. Before each ramp operation is performed, the comparator latch 370 is reset (forcing the comparator output to a low level) by enabling the latch reset control signal LTCH_RST_N. As the ramp voltage 323 changes, amplifier 360 input compares the input voltage—determined by both the ramp voltage and the sampled value to be converted—with the reference voltage VREF on second terminal 362. When these two values become equal, amplifier 360 flips its output voltage level 369. This change in the amplifier output voltage 369 causes the comparator output 329 of shared comparator 327 to flip from one state to another. After four ramp-down operations, the reset values for four different pixels are stored in the memory and the first reset ADC phase is completed.

After the reset levels of four pixels are converted, the charge stored at the photodiode during the exposure time is transferred to the pixel FD node 225. This transfer causes a change in the output voltage of the source follower 227. Similar to the reset phase, signal sampling and ADC operations are performed. The AZ switch 367 is used to sample the signal level on the input capacitors and four ramp-down operations are then applied to convert each sampled value into a digital signal. To complete the ADC operation for the structure shown in FIGS. 1-4, the entire sequence described (reset sampling, signal sampling, and ADC) is repeated for another set of four pixels. This ensures that all pixels in the unit are converted.

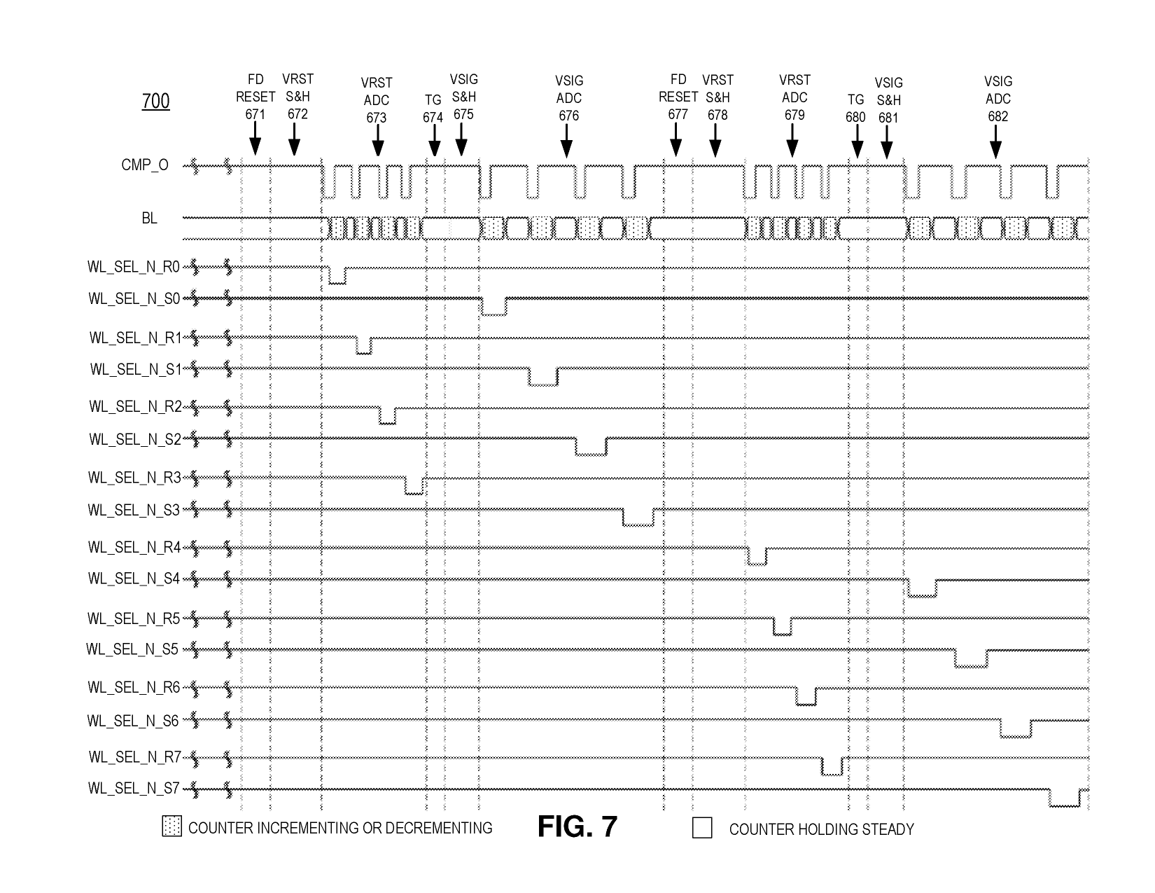

FIG. 7 illustrates a timing diagram 700 including signals CMP_O, BL, WL_SEL_N_R0, WL_SEL_N_R1, WL_SEL_N_R2, WL_SEL_N_R3, WL_SEL_N_R4, WL_SEL_N_R5, WL_SEL_N_R6, WL_SEL_N_R7, WL_SEL_N_S0, WL_SEL_N_S1, WL_SEL_N_S2, WL_SEL_N_S3, WL_SEL_N_S4, WL_SEL_N_S5, WL_SEL_N_S6, and WL_SEL_N_S7 during various time periods. As in FIG. 6, the time periods include Floating Diffusion reset 671, Reset Voltage Sample and Hold 672, VRST ADC 673, Transfer Gate 674, Signal Voltage Sample and Hold 675, Signal Voltage ADC 676, Floating Diffusion Reset 677, Reset Voltage Sample and Hold 678, Voltage Reset ADC 679, Transfer Gate 680, Signal Voltage Sample and Hold 681, and Signal Voltage ADC 682.

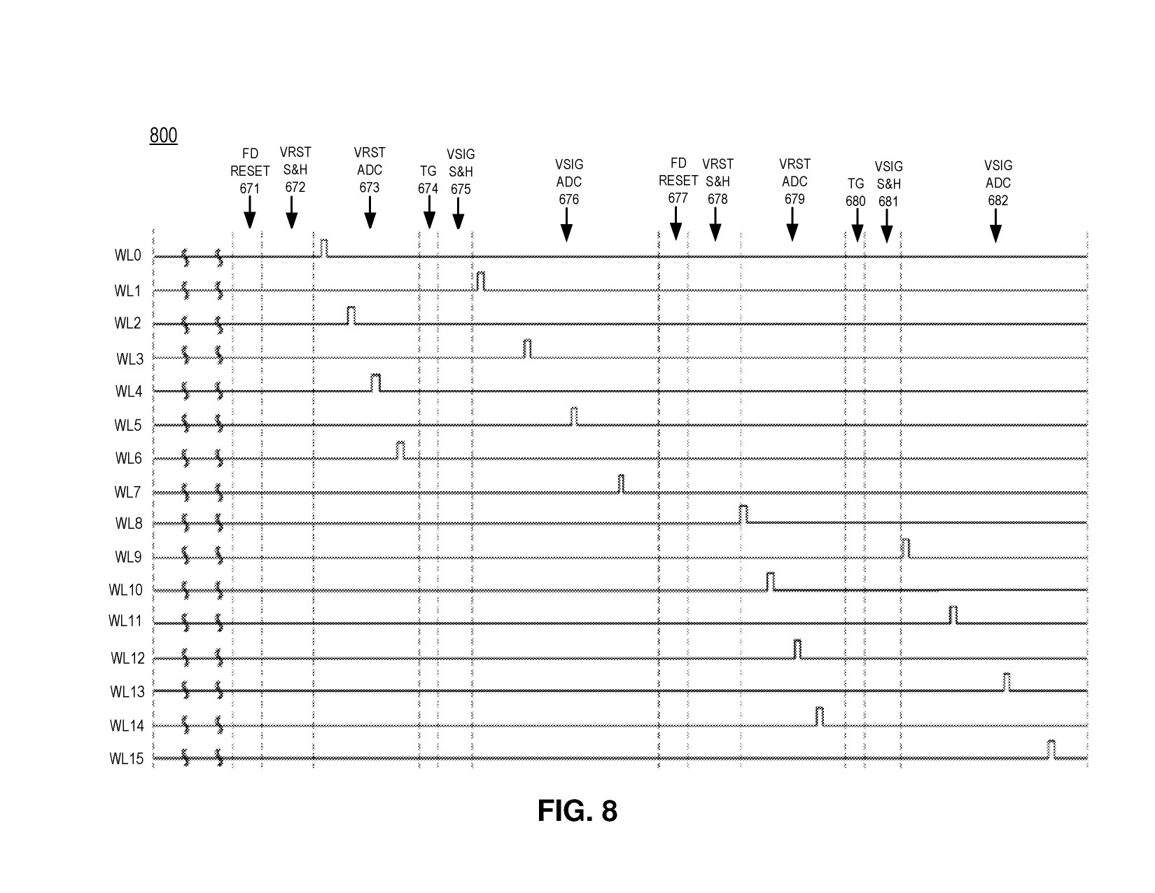

FIG. 8 illustrates a timing diagram 800 including signals WL0, WL1, WL2, WL3, WL4, WL5, WL6, WL7, WL8, WL9, WL10, WL11, WL12, WL13, WL14, and WL15. The time periods in timing diagram 800 include Floating Diffusion reset 671, Reset Voltage Sample and Hold 672, VRST ADC 673, Transfer Gate 674, Signal Voltage Sample and Hold 675, Signal Voltage ADC 676, Floating Diffusion Reset 677, Reset Voltage Sample and Hold 678, Voltage Reset ADC 679, Transfer Gate 680, Signal Voltage Sample and Hold 681, and Signal Voltage ADC 682.

The timing diagrams 700 and 800 in FIGS. 7 and 8 illustrate how the comparator output (e.g. comparator output 329) generates WL pulses (from WL0 to WL15) on the corresponding memory banks in this disclosure. For the structure described in FIGS. 1-4, the word line (WL) select signals are named WL_SEL_N_R for reset and WL_SEL_N_S for signal and range from 0 to 7. When a word line select signal is disabled, the corresponding memory WL is also disabled, preventing the memory from storing digital values. During ADC operation, the word line select driving signal is enabled for the corresponding pixel and voltage level (reset or signal) and the flipping of the WL memory is controlled by shared comparator 327 . The flipping time of comparator output 329 depends on the input signal value (generated by the image pixel) and enables the storage of the correct digital value from the digital counter 433 into the selected memory bank.

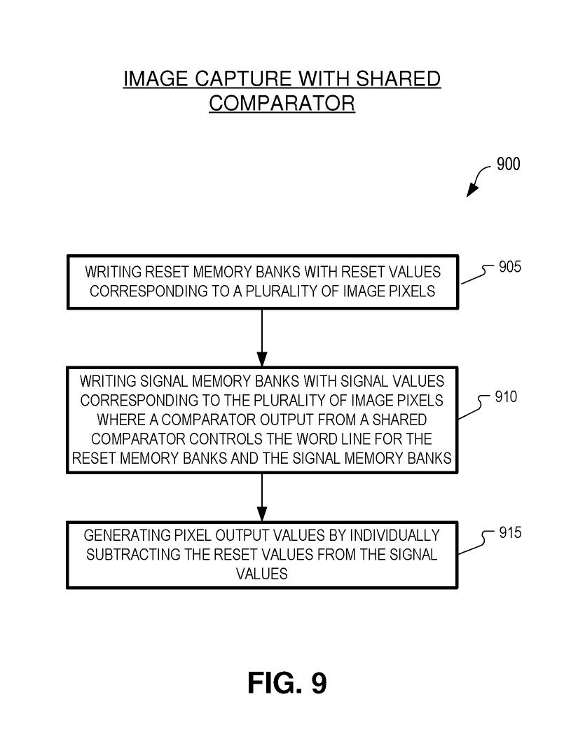

FIG. 9 illustrates a flow chart illustrating an example process 900 of capturing images with a shared comparator, in accordance with aspects of the disclosure. The order in which some or all of the process blocks appear in process 900 should not be deemed limiting. Rather, one of ordinary skill in the art having the benefit of the present disclosure will understand that some of the process blocks may be executed in a variety of orders not illustrated, or even in parallel.

In process block 905, reset memory banks are written with reset values corresponding to a plurality of image pixels. The comparator output controls a word line (WL) for the reset memory banks.

In process block 910, signal memory banks are written with signal values corresponding to the plurality of image pixels. A shared comparator (e.g. shared comparator 327) that generates the comparator output (e.g. output 329) is configured to receive a plurality of image charges from the plurality of image pixels. The comparator output that controls the WL for the reset memory banks also controls the WL for the signal memory banks.

In process block 915, pixel output values are generated individually by subtracting the reset values from the signal values for individual pixels in the plurality of image pixels. A digital image may be generated by combining the pixel output values. The digital image may be considered an image generated by CDS techniques.

In an implementation of process 900, the plurality of image pixels are included in an imaging semiconductor layer of an imaging device. In this implementation, the reset memory banks and the signal memory banks are included in a memory layer and the shared comparator is included in an analog semiconductor layer disposed between the imaging semiconductor layer and the memory layer.

In an implementation, the shared comparator includes a differential input amplifier configured to receive the plurality of image charges from the plurality of image pixels and a latch configured to flip a latch output in response to receiving an amplifier output from the differential input amplifier. The latch output may be the comparator output that controls the WL for the reset memory banks and the signal memory banks.

In an implementation, memory logic is coupled between the latch and the signal memory banks. The memory logic is configured to output the WL for the reset memory banks and the signal memory banks in response the comparator output. The memory logic may include NOR gates having individual selection inputs to individually select which of the reset memory banks or signal memory banks will be written. The remaining inputs of the NOR gates may be coupled to receive the comparator output.

In an implementation of process 900, the image pixels in the plurality of image pixels have photodiodes that share a floating diffusion (FD) and each of the photodiodes generates one of the reset values and one of the signal values.

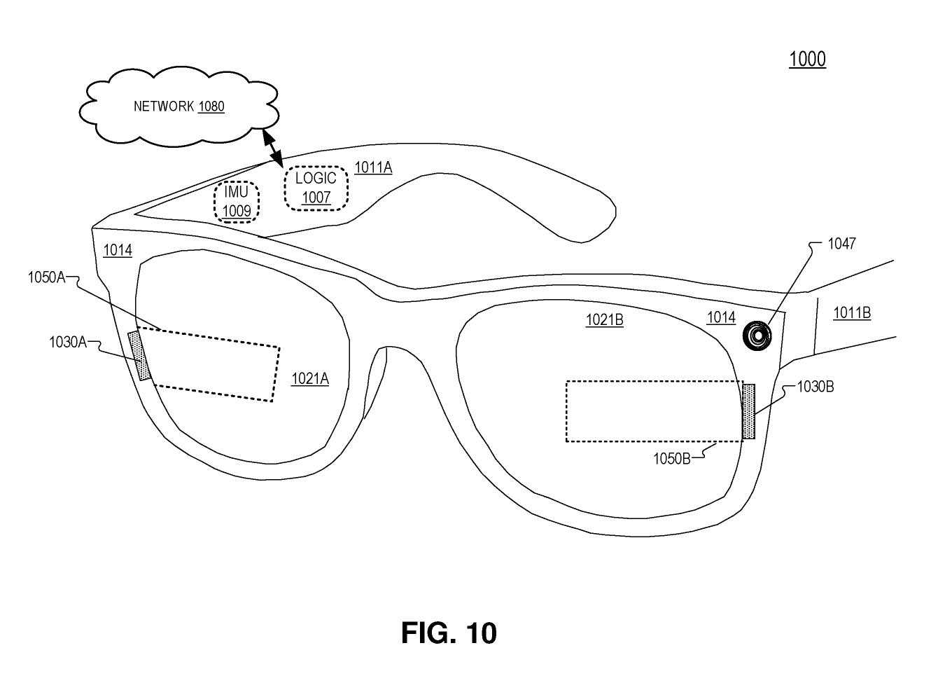

FIG. 10 illustrates a head-mounted device 1000 that includes one or more cameras 1047 that may be exposed to an external environment, in accordance with aspects of the present disclosure. Camera(s) 1047 may include the imaging devices and be operated according to the techniques described in this disclosure. Camera 1047 may be exposed to an external environment of the head-mounted device 1000. Head-mounted device 1000 includes frame 1014 coupled to arms 1011A and 1011B. Lens assemblies 1021A and 1021B are mounted to frame 1014. Lens assemblies 1021A and 1021B may include prescription lenses matched to a particular user of head-mounted device 1000. The illustrated head-mounted device 1000 is configured to be worn on or about a head of a wearer of head-mounted device 1000.

In the head-mounted device 1000 illustrated in FIG. 10, each lens assembly 1021A/121B includes a waveguide 1050A/1050B to direct image light generated by displays 1030A/1030B to an eyebox area for viewing by a user of head-mounted device 1000. Displays 1030A/1030B may include a beam-scanning display or a liquid crystal on silicon (LCOS) display for directing image light to a wearer of head-mounted device 1000 to present virtual images, for example. Hence, head-mounted device 1000 may be considered a head-mounted display (HMD) when a near-eye display is included in head-mounted device 1000.

Lens assemblies 1021A and 1021B may appear transparent to a user to facilitate augmented reality or mixed reality to enable a user to view scene light from the environment around them while also receiving image light directed to their eye(s) by, for example, waveguides 1050. Lens assemblies 1021A and 1021B may include two or more optical layers for different functionalities such as display, eye-tracking, and optical power. In some embodiments, image light from display 1030A or 1030B is only directed into one eye of the wearer of head-mounted device 1000. In an embodiment, both displays 1030A and 1030B are used to direct image light into waveguides 1050A and 1050B, respectively. The implementations of the disclosure may also be used in head-mounted devices (e.g. smartglasses) that don’t necessarily include a display but are configured to be worn on or about a head of a wearer.

Frame 1014 and arms 1011 may include supporting hardware of head-mounted device 1000 such as processing logic 1007, a wired and/or wireless data interface for sending and receiving data, graphic processors, and one or more memories for storing data and computer-executable instructions. Processing logic 1007 may include circuitry, logic, instructions stored in a machine-readable storage medium, ASIC circuitry, FPGA circuitry, and/or one or more processors. In one embodiment, head-mounted device 1000 may be configured to receive wired power. In one embodiment, head-mounted device 1000 is configured to be powered by one or more batteries. In one embodiment, head-mounted device 1000 may be configured to receive wired data including video data via a wired communication channel. In one embodiment, head-mounted device 1000 is configured to receive wireless data including video data via a wireless communication channel. Processing logic 1007 may be communicatively coupled to a network 1080 to provide data to network 1080 and/or access data within network 1080. The communication channel between processing logic 1007 and network 1080 may be wired or wireless.

In FIG. 10, head-mounted device 1000 includes an inertial measurement unit (IMU) 1009 configured to generate motion signals. IMU 1009 may be communicatively coupled to processing logic 1007. Processing logic 1007 may be configured to receive motion signals from IMU 1009. IMU 1009 may include gyroscopes to measure angular velocity, accelerometers to detect linear acceleration, and/or magnetometers to sense the magnetic field of the earth. All or a portion of the signals may be included in the motion data generated by IMU 1009. IMU 1009 may provide motion data to calculate position and attitude (orientation) of the head-mounted device 1000 over time.

In the illustrated implementation of FIG. 10, head-mounted device 1000 includes a camera 1047. Camera 1047 is illustrated as a front-facing camera in FIG. 10, although cameras described in the disclosure may be oriented to capture images from alternative perspectives. Head-mounted device 1000 may include more than one camera that includes the features described herein.

Camera 1047 may include a lens assembly configured to focus image light to a complementary metal-oxide semiconductor (CMOS) image sensor, in some implementations.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g. processing logic 101) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” (e.g. memories 480-487 and memories 490-497) described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. An imaging device comprising:
a plurality of image pixels disposed on an imaging layer;
an analog layer including a shared comparator configured to receive image charges from the plurality of image pixels; and
a memory layer including reset memory banks and signal memory banks, wherein the analog layer is disposed between the imaging layer and the memory layer, and wherein a comparator output of the shared comparator controls a memory control line for both the reset memory banks and the signal memory banks.

2. The imaging device of claim 1, wherein the shared comparator includes:
a differential input amplifier configured to receive the image charges from the plurality of image pixels; and
a latch configured to flip a latch output in response to receiving an amplifier output from the differential input amplifier, wherein the latch output is the comparator output that controls the memory control line for the reset memory banks and the signal memory banks, the memory control line being a word line (WL).

3. The imaging device of claim 2, wherein the memory layer includes memory logic electrically coupled between the latch and the signal memory banks, and wherein the memory logic is configured to output the WL for the reset memory banks and the signal memory banks in response the comparator output received from latch.

4. The imaging device of claim 3, wherein the memory logic includes NOR gates having individual selection inputs to individually select which of the reset memory banks or signal memory banks will be written to, and wherein remaining inputs of the NOR gates are coupled to receive the comparator output.

5. The imaging device of claim 1, wherein the image pixels in the plurality of image pixels have photodiodes that share a floating diffusion (FD), and wherein each of the photodiodes generates (1) a reset value stored to a corresponding reset memory bank in the reset memory banks; and (2) a signal value written to a corresponding signal memory bank in the signal memory banks.

6. The imaging device of claim 1, wherein the analog layer further includes input capacitors coupled between the image pixels and the shared comparator.

7. The imaging device of claim 6, wherein the shared comparator includes a differential input amplifier having a first terminal coupled to the input capacitors through enable switches, wherein the differential input amplifier also includes a second terminal for receiving a reference voltage.

8. The imaging device of claim 7, wherein the analog layer further includes a ramp circuit including ramp-enabled switches configured to sequentially apply a ramp voltage to the input capacitors.

9. The imaging device of claim 8 further comprising:
a digital counter that counts up or down in synchronization with the ramp voltage of the ramp circuit, wherein a memory bit line (BL) interconnected with the reset memory banks and the signal memory banks is connected to the digital counter.

10. The imaging device of claim 7, wherein the enable switches are configured to be sequentially opened during a reset phase that measures reset values for the plurality of image pixels, and wherein the enable switches are also configured to be sequentially opened during a signal phase that measures signal values for the plurality of image pixels.

11. The imaging device of claim 10, wherein the analog layer includes an autozero switch coupled between the first terminal of the differential input amplifier and a latch configured to flip a latch output in response to receiving an amplifier output from the differential input amplifier.

12. The imaging device of claim 7, wherein the analog layer includes a discharge circuit coupled to the first terminal of the differential input amplifier, wherein the discharge circuit is tied to a discharge voltage and provides a discharge path for charge stored in the input capacitors.

13. The imaging device of claim 1, wherein each of the plurality of image pixels has a corresponding reset memory bank to store reset values and a corresponding signal memory bank to store signal values.

14. The imaging device of claim 1, wherein the comparator output generates pulses on the memory control line to write to the reset memory banks and the signal memory banks.

15. A method comprising:
writing reset memory banks with reset values corresponding to a plurality of image pixels, wherein a comparator output controls a word line (WL) for the reset memory banks;
writing signal memory banks with signal values corresponding to the plurality of image pixels, wherein a shared comparator that generates the comparator output is configured to receive a plurality of image charges from the plurality of image pixels, and wherein the comparator output that controls the WL for the reset memory banks also controls the WL for the signal memory banks; and
generating pixel output values by individually subtracting the reset values from the signal values for individual pixels in the plurality of image pixels.

16. The method of claim 15, wherein the plurality of image pixels are included in an imaging semiconductor layer of an imaging device, the reset memory banks and the signal memory banks are included in a memory layer, and the shared comparator is included in an analog semiconductor layer disposed between the imaging semiconductor layer and the memory layer.

17. The method of claim 15, wherein the shared comparator includes:
a differential input amplifier configured to receive the plurality of image charges from the plurality of image pixels; and
a latch configured to flip a latch output in response to receiving an amplifier output from the differential input amplifier, wherein the latch output is the comparator output that controls the WL for the reset memory banks and the signal memory banks.

18. The method of claim 17, wherein memory logic is coupled between the latch and the signal memory banks, and wherein the memory logic is configured to output the WL for the reset memory banks and the signal memory banks in response the comparator output.

19. The method of claim 18, wherein the memory logic includes NOR gates having individual selection inputs to individually select which of the reset memory banks or signal memory banks will be written, and wherein remaining inputs of the NOR gates are coupled to receive the comparator output.

20. The method of claim 15, wherein the image pixels in the plurality of image pixels have photodiodes that share a floating diffusion (FD), and wherein each of the photodiodes generates one of the reset values and one of the signal values.
